(19) United States
(12) Patent Application Publication
(10) Pub. No.: US 2007/0291669 A1
(43) Pub. Date: Dec. 20, 2007

(54) Method and apparatus for a hybrid network service

(76) Inventor: Terry D. Perkinson, Roseville, CA (US)

Correspondence Address: OKAMOTO & BENEDICTO, LLP, P.O. BOX 641330, SAN JOSE, CA, 95164, US

(21) Appl. No.: 10/804,832

(22) Filed: Mar. 17, 2004

(51) Int. Cl. H04L 12/28

(52) U.S. Cl. 370/310; 370/351; 370/352

(57) ABSTRACT

An apparatus for data transfer comprising a first network, a second network, and a plurality of nodes on said first network wherein secured data is transferred between at least two nodes of said plurality of nodes on said first network only if said at least two nodes also exist on said second network.

### BACKGROUND

1. Field of the Disclosure

This invention relates generally to network services.

2. The Prior Art

### BACKGROUND

Significant changes are underway that will alter the way that video and other multimedia services such as music, electronic games, and Internet connectivity are delivered and distributed. Forces generated by the move from analog to digital video and music media, the increasing availability of broadband network services, and increasing use of VoIP telephone services is driving a rapid evolution toward the ubiquitous use of Ethernet and Internet Protocol (IP) networks to distribute that content throughout the home. Over time, this evolution will result in Ethernet/IP being the ‘pipe’ through which all telecommunications services are delivered to, and distributed within, homes and businesses.

The telecommunications industry is focused on delivering digital video, Internet, and voice services as a bundle, referred to as the “triple-play”. Most, if not all, cable, telephone, and utility companies today are working on plans to become a provider of the triple-play, as it essentially makes them the customer's sole telecommunications services provider, and provides a platform for delivering value-added services. There are a handful of small to mid-size triple-play providers in the U.S. today, but the big companies are beginning to plan and initiate their moves.

There are challenges facing this evolutionary process that the industry must overcome. Bandwidth and security services must be provided at adequate levels to ensure that the content is delivered to homes and distributed within homes in ways that maintain quality and that help to ensure copyrighted content can only be viewed, stored, or transported by authorized devices and users.

Video, such as a television channel carried by a cable company or satellite service, requires approximately 4 Mbps for one standard television channel delivered digitally, and 20 Mbps for one HDTV channel. The system must also be capable of transporting two or more television channels, Internet data traffic, and voice traffic simultaneously. Deploying an Ethernet/IP network to support these uses in a home requires Category-5 wiring everywhere the service is desired.

Stronger security measures are needed to satisfy the owners of digital content copyrights to the degree that they will allow carriers to transport copyrighted content over a wireless network. Content owning companies like ESPN, HBO, Showtime, Sony, etc. are very concerned and require strict security measures even on wired networks—much less wireless. Their concern is that the network could be compromised and the content, which is essentially a master copy, be obtained by unauthorized users. Also, businesses providing Internet connectivity via xDSL and cable modem also are concerned, as they do not want their services being delivered to the entire neighborhood by one home's wireless network.

The process proposed by the invention (herein also called Hybrid Network Solution or HNS) utilizes current and emerging home networking technologies to provide a solution that can meet the above needs while providing flexible, scalable functionality and security.

HNS requires all participating nodes to exist on both the wired and wireless networks simultaneously and be authenticated, and continually re-authenticated, as an authorized sender and/or receiver on the wireless (and potentially wired) network to deliver data securely. Nodes cannot use the hybrid wireless network without negotiating, and continually re-negotiating, over the wired portion of the network.

No encryption keys or other security data need be transferred over the wireless network at all, only pure encrypted payload. Therefore any eavesdropping of the cleartext portion of the wireless data traffic will yield only encrypted data—no protocol negotiation packets, no hints for hackers to leverage in decrypting the data.

Also, In the case of a video service provider, the video stream (television channel) is encrypted at the headend and cannot be decrypted until it reaches the digital set-top-box. So the HNS encryption of that stream is a super-encryption effect. HNS does not have, nor require, access to the decrypted content. HNS is agnostic to whatever it transports, providing secure bandwidth, and not knowing or caring what information is actually transported. This makes HNS flexible in its application.

The invention provides a new way of utilizing existing wired and wireless network technologies together to provide a wireless service that is far more secure than anything available today. It does so by providing the necessary control processes and logic to require all participating nodes to be reachable continuously on the home electrical wiring network as well as the wireless network, in addition to having the correct security credentials, to be able to negotiate for use of the wireless network.

When implemented the invention will enable installation of a flexible, scalable multimedia Ethernet/IP hybrid wired/wireless network in a home or similar facility without requiring costly, time-consuming re-wiring.

Scalability is achievable by installing different interfaces creating embodiments to support various devices. For example, by replacing the coax cable Content Interface Module (CIM) in the base unit, with a CIM that connects to a DVD player, one could distribute the DVD output around the home to other HNS boxes connected to TVs.

Content Interface Module. Term used in this document to indicate a module that interfaces HNS to a content stream source or content stream receiver, or both. Examples include: 1) Ethernet module for connection to a native Ethernet source; 2) An STB module to provide connectivity to a television; 3) A cable modem or xDSL modem to connect to a cable or telephone companies broadband Internet service; 4) A Component Video (or RGB) to Ethernet conversion module that would allow connecting a standard DVD player to an HNS box and one (or more) HNS box would be connected to a television. This allows sharing of a DVD player or recorder in a home; and 5) A module that converts a signal that normally would be sent over a cable of some sort to another device (such as a SVHS, Audio-Out, etc.) to/from Ethernet that when coupled to an appropriate short range wireless system, would enable an embodiment of HNS that provides a “virtual cabling” system that would eliminate the need to interconnect home entertainment equipment for example with a myriad of cables.

Even ‘man-in-the-middle’ attacks will not succeed due to the authentication process requiring nonces and a pre-shared key (PSK), which is installed at the factory, by the installer, or end-user, and is never put on the wired or wireless network. The exchange of nonces is done over the wired network (not the wireless network) by participating nodes and therefore the nonces are not available to the man-in-the-middle. The man-in-the-middle can intercept wireless packets, and thereby obtain the MAC and IP addresses of the sender and receiver, but cannot form the encryption keys due to lack of PSK and nonces from each node. Hacking into the HNS wireless network will be far more difficult than any wireless-only scheme.

The HNS is not device specific by nature, though could be constrained to proprietary devices only by any particular manufacturer. There may be advantages to integrating HNS into a set-top-box and have HNS participate in the security measures between the set-top-box and headend since there is nothing in the HNS that would prevent such and embodiment.

If needed, the wireless network could be restricted only to those who can authenticate with HNS. It could though also be shared with ‘regular’ wireless users with the restriction that HNS have the highest QoS, and highest priority and bandwidth allocation.

There is an issue with support for laptop computers, and PDAs, and other high mobility devices that use IEEE 802.11x the wireless networks and that are not continuously plugged into an electrical outlet. One solution would be to configure HNS logic to segment the wireless bandwidth allocating the best QoS and necessary bandwidth to HNS nodes first, but leaving the remainder available to non-HNS nodes. VLANs could be employed for example. However, these mobile devices are not candidates for full HNS support.

Another solution would be to use multi-mode wireless controllers. Multi-mode wireless controllers utilize more than one wireless standard such as 802.11b and 802.11g in one unit or box. By allocating the appropriate service or services to HNS and others for use as a ‘standard’ non-HNS wireless system a non-HNS laptop, PDA or other device could still get on the wired network but could not access resources controlled by HNS. For example, a multi-mode controller could be employed having both 802.11b and 802.11g. HNS could allocate the 802.11g services to HNS nodes and transparently provide the 802.11b services to non-HNS nodes.

Where support of non-HNS devices is important, HNS can be implemented in ways that will accommodate those devices. However, there could be implementations where a service provider may want to lock down the entire wireless and/or wired network to only the devices and services they provide/allow, and not allow use by other devices.

HNS would be best implemented if a QoS mechanism were included, though QoS is not strictly required. Implementation of HNS without QoS would best be accomplished by dedicating the entire wireless network to HNS protected traffic only—no non-HNS wireless traffic allowed.

Another embodiment would be a way to connect new media devices in the home. Using very high bandwidth short-range wireless technologies the task of connecting a new home entertainment system would be greatly simplified. All of the signals that formerly traveled over myriad cables could instead move over HNS. HNS will support any wireless technology or technologies in a particular embodiment; the fundamental invention does not care as long as the technology allows the necessary level of control by a central processor.

Installing a new home entertainment system (with the invention embodied in each component) consisting of a surround sound receiver, DVD player, Television, CD player, and possibly other media components amounts only to plugging the speakers into the receiver and all other components into the electrical outlet. The devices would authenticate each other over the home electrical wiring network (HEWN), then software in those devices would ‘talk’ to the other devices, configure itself accordingly, and begin operating over the wireless ‘virtual cables’. While HNS would not provide the logic or control protocols that recognize and interconnect different media devices, it would provide the network bandwidth, management, and security that those protocols utilize. Again, HNS is agnostic to the functionality carried by its services so this implementation of an HNS controller would be essentially identical to that in a digital STB.

The invention could also provide the core home network for adding digital multimedia support to home electrical appliances. As business needs arise that drive more functionality and connectivity needs into appliances such as refrigerators, the invention can connect these devices to each other, a home systems controller of some sort, a home entertainment system, or to the Internet. These devices could utilize the HEWN network and could connect to the Internet for user control, monitoring, or troubleshooting by a vendor or repair service.

The wireless service could be used to embed video media into the devices as desired. If a business case can be made for putting a television screen in a refrigerator door, then HNS could provide the network. Many people seem to have a TV in the kitchen today, so at least integrating the television into the refrigerator would save some space, and HNS would eliminate the need to install Cat-5 wiring to the refrigerator.

The invention may find use in areas other than the home. Basically anywhere that a wireless network needs to be secured, and there exists a wired network (preferably a HEWN) that can be utilized, the invention could be deployed to achieve some purpose.

There might be problems in large enterprise electrical facilities in using HomePlug as the wired network in those environments as it was not designed for that environment. But as there are efforts underway to deliver broadband services over a utility electrical grid, those efforts may resolve any issues. If another version of HomePlug is required, or another standard is developed to support large facility electrical systems, it could be incorporated into an embodiment of the invention in place of HomePlug.

Another use may be in the area of longer range fixed wireless broadband services like those under development in the IEEE 802.16 committee. To prevent unauthorized use, the invention could be embodied in such a way that the service provider can authenticate devices using its wireless service over the public electrical network. Technology would have to exist to support a wide area electrical grid network, but there are efforts underway to develop such services and early trials are already underway in Europe if not the U.S.

There are multiple ways to carry out the invention depending on the business need addressed. In optimal implementations, the invention would reside on a programmable controller connected to various network interfaces that is programmed to carry out the HNS process. The interconnection of the controller and interfaces would provide the level of control over those interfaces to meet the needs of the particular design. See FIG. 3.

The invention process could be implemented either on a dedicated controller or on an existing CPU (see FIG. 5) if that CPU is physically able to control the necessary network interfaces and has the necessary processing power. The invention is a centralized control service for all necessary network interfaces in the box much like other processes run by a CPU in a common home network router. See FIG. 5.

Because the invention is compatible with Ethernet/IP, there is nothing preventing its implementation on widely available programmable controllers identical or similar to those used today in a residential/small-business grade wireless AP/routers to implement its central control services. Given enough CPU power and the right interfaces, the invention could be implemented on the same controller as other CPU functions in those routers. Theoretically, the Siemens 2524 mentioned earlier for example could be a candidate for this kind of implementation. In this case the invention would be a software upgrade to that device. See FIG. 3 and FIG. 5.

Practically any wireless controller may be used, as there is many to choose from today implemented in mass-produced wireless APs and wireless AP/routers. Those implementing the 802.11x (and in the mid-term future, 802.15.x) family are preferred due to their acceptance, availability, and low cost. Wireless Access Point (AP) functionality would be included in at least the base unit implementation.

The wired portion of the network (HEWN) used for control and lower bandwidth traffic, would most likely to be based upon the HomePlug standard (or equivalent). HomePlug provides Ethernet over home electrical wiring at 14 Mbps with a throughput of about 5 Mbps. That throughput is too low for a home digital content distribution system, hence the need for the wireless connection with it's higher bandwidth. HomePlug, when used as a component of the HNS, provides adequate bandwidth for the Internet/data and VoIP telephone portion of the triple-play as well as the HNS control traffic. Video traffic would traverse the HNS wireless connection.

The primary implementation of the invention over time is its full integration into many different kinds of network and media devices themselves. Digital STBs, DVD players, CD players, PCs, game consoles, PVRs, routers, and similar devices that communicate using Ethernet/IP would benefit from the invention's features; the secure wireless network, the use of the HEWN for Internet, VoIP, and other non-protected traffic, and not requiring expensive Cat-5 wiring be installed.

### BRIEF DESCRIPTION OF THE DRAWING FIGURES

FIG. 1 is shows an overview of an example implementation showing fully integrated and standalone box embodiments of the invention process logic for the purpose of delivering digital multimedia in the home.

FIG. 2 shows an embodiment of the invention as a wireless video distribution network in a home for a cable, Telco/xDSL, or satellite video service provider;

FIG. 3 is a block diagram of HNS as a standalone black box;

FIG. 4 shows an overview of the basic logic of the HNS module; and

FIG. 5 shows a standard home router without HNS and the same router with integrated HNS.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

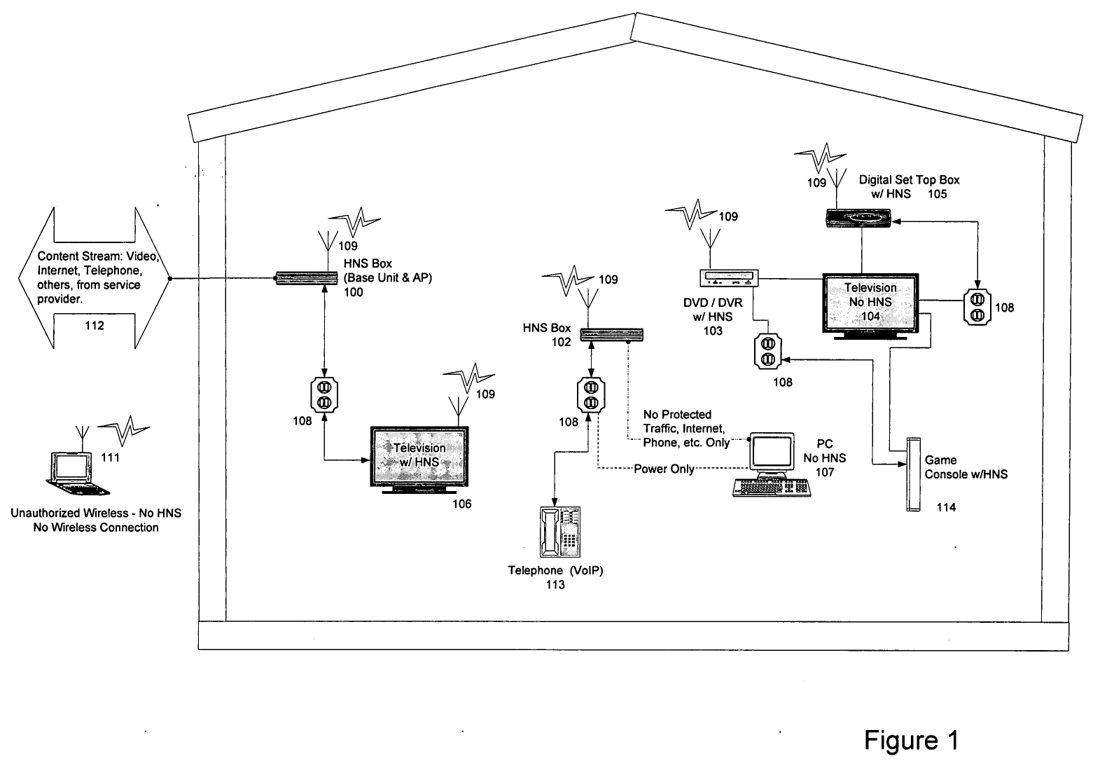

FIG. 1 shows an overview of an example implementation showing fully integrated and standalone box embodiments of the invention process logic for the purpose of delivering digital multimedia in the home. Multiple sources of content 103, 107,112 flow into the HNS and may then be distributed on the wireless network 109, or over the HEWN 108 as determined by the service level negotiated by the source and receiver. Note that the PC 107 is only able to access the HEWN for Internet access via 102, and other normal data network functions, but content from the cable company or any other HNS protected source, such as the DVD player, will not be accessible by the PC.

The HEWN 108 is used for HNS security negotiations and other network services that may or may not be available to non-HNS nodes. Internet 107 and telephone service 113 are the two most likely services, which along with video constitute the triple-play. Devices must plug into electrical outlets 108 to utilize HNS as all network service control and negotiation occur over the HEWN.

The VoIP telephone 113 could run either as a managed device provided by the connected service provider, or could be a service of an Internet based phone company such as Vonage and the voice traffic would simply travel over the HEWN as any other Internet traffic would. Either way can be controlled by, or transparent to, HNS.

The gaming console 114 is similar to the VoIP phone in that it may run outside HNS, or if desired for instance using a service provider for network access and/or games, it could be controlled by HNS. HNS control may be desired as well to prevent unauthorized access of the game console.

The digital STB 105 communicates with the service provider headend via the HNS wireless network 109 through the base unit—HNS Box 100. The HNS Box 100 also serves as the wireless AP for the home. The DVD/DVR can distribute it's content securely over the wireless network to Television 106. It also could be connected to Television 104 in the traditional way by a cable. Note that the DVD could be anywhere in the home and still provide service to another television if that television has integrated HNS or has an external HNS box (equipped with a TV-signal-out interface) connected to its input jack.

All HNS devices negotiate over HEWN 108 for the ability to use HNS resources (like HNS wireless). The HEWN is fully functional for non-HNS devices other than those devices cannot access HNS managed resources.

The potential unauthorized user wireless or hacker 111 is shown and cannot use the wireless network as it is not on the HEWN and does not have the PSK, nonces, etc.

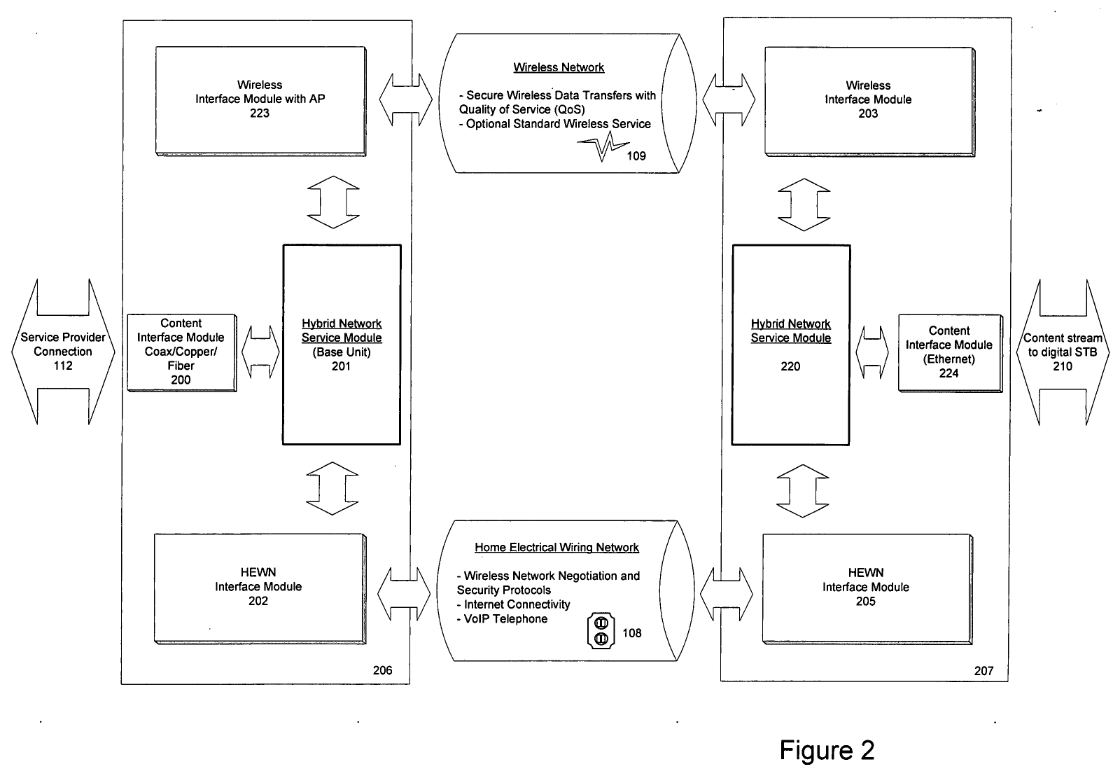

FIG. 2 is a block diagram depicts an embodiment of the invention as a wireless video distribution network in a home for a cable, Telco/xDSL, or satellite video service provider. A simplified example of how two HNS modules might discover, authenticate, exchange encryption keys, perform data transfer, maintain authentication, and eventually de-authenticate (disconnect) is presented below.

HNS expects to use security mechanisms provided by the wired network itself though it can and may encrypt certain packets before forwarding onto the wired network if the wired network provides no or inadequate encryption capability. The same may be said of the wireless network. Depending on the need, HNS could perform it's own encryption on top of the encryption capability provided by the wireless or wired network module's controllers (super encryption), or not encrypt and rely completely on the network controllers to do so.

Note that different protocols may be used for negotiation between HNS nodes depending on the needs of a particular implementation. Implementations may vary in complexity based upon the business need. This example is generic and not meant to specify any particular method. Multicast (or group) authentication and key creation is a similar.
1. The HNS module 201 in HNS Box 206 sends an unencrypted packet to the HNS module 220 in HNS Box 207 over the HEWN 202, 108, 205 requesting that the authentication process begin for the privileged HNS wireless service. HNS 201 placed its wireless MAC address in the packet's data area, but no keys or nonces. HNS 220 saves HNS 201 wireless MAC address (from the data area of the packet, not the HEWN MAC address in the source address field of the packet), which is one of the parameters required to compute the temporal encryption keys.
2. HNS (220) then sends unencrypted response to HNS 201 via HEWN 205, 108, 202 that contains an Anonce and its own wireless MAC address in the data area of the response packet. Since it generates its own nonce (Snonce), HNS 201 now can compute the four temporal keys, referred to as Tk (1,2,3,4). Tk (1,2,3,4) is a function of (Anonce, Snonce, both wireless MAC addresses, and the PSK).
3. HNS 201 sends unencrypted message back to HNS 220 containing the Snonce and a MIC (Message Integrity Check) field. HNS 220 now computes the temporal keys and uses the Key Integrity key to validate the MIC. Neither side has yet begun encryption.
4. HNS 220 sends unencrypted message to HNS 201 that contains a MIC and the starting sequence number for the first encrypted frame.
5. HNS 201 sends unencrypted message to HNS 220 acknowledging the end of the four-way handshake process and provides its starting sequence number. HNS 201 now installs the keys and all further messages will be encrypted.
6. HNS 220 receives the message from HNS 201 and installs the keys. From this point encrypted data transfers between HNS 220 and HNS 201 may occur on the privileged wireless service 109 until the connection is de-authenticated (closed).
7. The television channel can now be carried from the source 112 to the digital STB 210 securely through HNS.
8. Keys will periodically expire and require re-authentication and re-generation, based upon the security protocol chosen. And either side may close the connection by sending the other a request to de-authenticate.

Packets arriving on the network interfaces 200, 202, 223, 224, 203, 205 are forwarded normally as long as HNS protected sources and/or destinations authorized, or if the packet is from and to a non-HNS network. This behavior assumes HNS does not control either the HEWN or the non-HNS portion of the wireless network as a ‘protected’ network.

Note that if the Ethernet CIM 210 in HNS Box 207 were replaced with a digital STB CIM, the external STB would not be required, and HNS Box 207 would effectively be a secure, wireless digital STB.

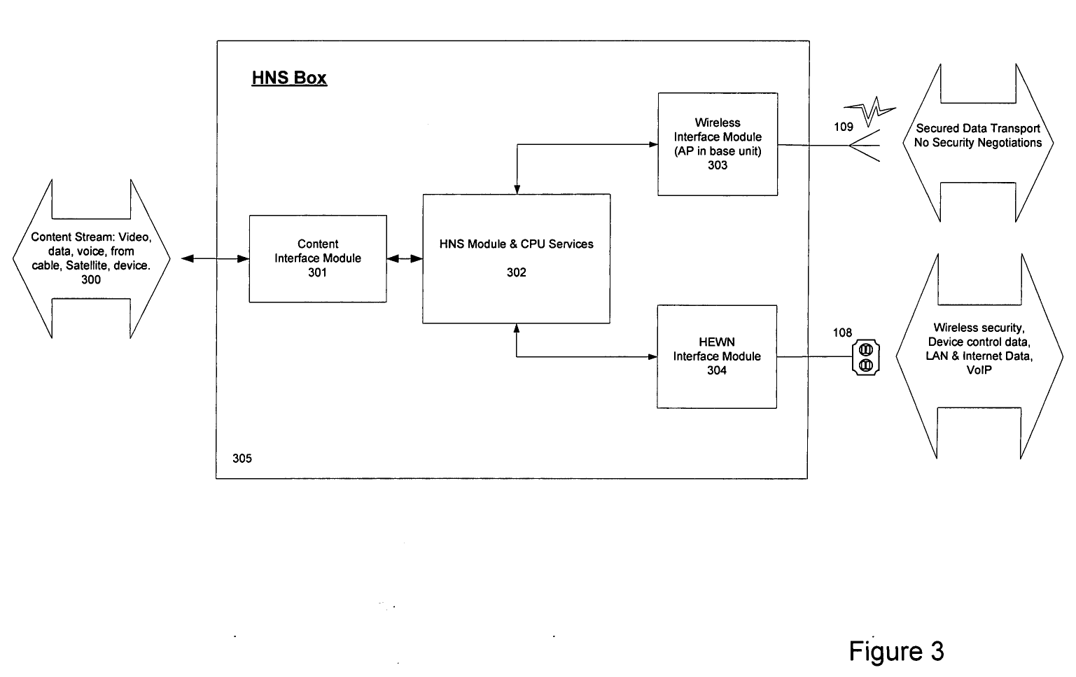

FIG. 3 is a block diagram of HNS as a standalone black box 305. The HNS module 302 manages and controls the three network interfaces—the source port 301; wireless port 303; and HEWN port 304—in such a way as to provide the security and bandwidth management required for a particular implementation.

It is important to note that 301 could instead be a digital STB module in the case where HNS is integrated into an STB as shown in FIG. 1 105. This block diagram however depicts a base unit that would be connected to the service provider's demarcation point at the home as shown on FIG. 1 100. The functionality of HNS is the same either way. While HNS may be configured to operate somewhat differently in various implementations, the fundamental invention process is the same in all implementations.

When a packet arrives on the source interface module 301 from the source 300 that is addressed to a node on the HNS wireless network 109, the HNS module 302 (in the base unit this is also the AP) determines whether the packet can be forwarded by the wireless module 303 or not. Assuming all authentications are in place, the packet is encrypted using the keys generated by the authentication process with the destination HNS, and given to the wireless module 303. The wireless module 303 transmits the packet over the wireless media 109 for reception by the other HNS entity.

When a packet arrives from the HNS wireless network 109 the wireless module 303 gives it to the HNS module 302. That HNS module 302 verifies that the source is authorized, then decrypts the packet and if successful, gives the decrypted packet to the appropriate interface controller for forwarding.

As shown, the wireless network 109 is used for encrypted data transmissions between authorized HNS nodes. The HEWN 108 is used for security negotiations and for standard HEWN data traffic on the home network. This may include Internet access traffic, and VoIP telephone traffic, game console traffic etc.

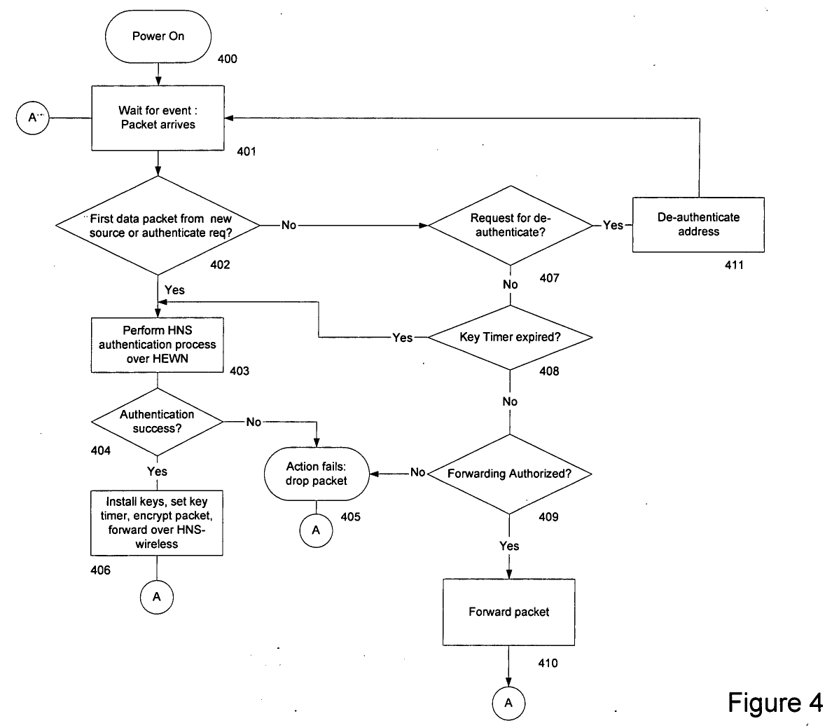

FIG. 4 shows an overview of the basic logic of the HNS module. After power up and initialization, the HNS enters a state that it is waiting for a packet that will trigger some action. For example, say turning on an STB will cause it to send a packet to the headend. The HNS attached to this STB will receive this packet from the interface and then begin the authentication process to establish an authenticated relationship to the HNS that connects to the headend.

Note: Alternatively, HNS could actively search for other HNS devices on the HEWN, without waiting for triggering events and establish authenticated connections with all discovered nodes. However the connections time-out, and if HNS devices are not exchanging data, the overhead involved in continually timing out and re-establishing connections is a waste of resources. However there may be implementations where this active discovery process is desirable. This example assumes event driven connections.

Beginning with item 400, the device is powered on then goes into a state waiting for a triggering event—there are no connections to other HNS devices at this time. At 401, some triggering event occurs:
1. An initial packet from a source that is addressed to an as of yet un-connected HNS;
2. An authentication request packet from another HNS;
3. A de-authentication request packet from a connected HNS which wants to close the connection between the two devices and disassociate itself from this HNS;
4. A regular payload data packet that—if authorizations are in order—will be forwarded.
5. A non-HNS packet is received on the HEWN (or non-HNS wireless if HNS is so implemented) with a destination address on the HEWN or non-HNS wireless—in other words the non-controlled regular network. (Note that this case is subject to design requirements for a particular implementation. Some implementations may lock down everything by having HNS manage all data traffic. Others may have HNS only control the HNS-wireless virtual network. The latter is assumed here in this example.)

Event 1: In this case, HNS needs to establish a connection 403 with an HNS on the wireless network. HNS will execute a discovery process over the HEWN to find the device having the wireless address contained in the destination field of the packet. Once HNS knows the HEWN and HNS-wireless (HNS-W) addresses of the destination, it then carries out the authentication process over the HEWN to verify that the device is authorized to participate. At 404 if the authentication fails, the packet is dropped and no further action taken 405. If the authentication succeeds encryption keys are installed and the packet is encrypted and forwarded over the new HNS-W connection 406. The flow is: 401, 402, 403, 404, 406, 401.

Event 2: If the packet is an authentication request packet from another HNS the path is: 401, 402, 403, 404, 406, 401. There is no data packet to forward in this case.

Event 3: If a packet is received from an HNS requesting that the connection be closed i.e. de-authenticated, the flow is: 401, 402, 407, 411, 401. The connection is closed, and each HNS de-authenticates the other.

Event 4: The receiving HNS will decrypts the packet using the current keys generated by the authentication process and forwards the packet to the proper interface. The flow is: 401, 402, 407, 408, 409, 410, 401.

Event 5: A packet is received from a non-HNS source address (HEWN, or non-HNS wireless if allowed) that has a non-HNS destination address. The flow is: 401, 402, 407, 408, 409, 410, 401. At 409 the packet is “authorized” because this implementation participates on the non-HNS networks like any other packet switch or routing device as long as HNS policies are not violated by doing so. So, the packet is forwarded.

Note the timer expiration decision blocks. These are depicted in the flows for clarity to show that the timer expiring stops a packet from being forwarded. The actual design would handle the timer as an interrupt instead of making the decision at each point shown.

An example might be an HNS home network with non-HNS controlled phone and Internet traffic running through HNS and possibly non-HNS network devices.

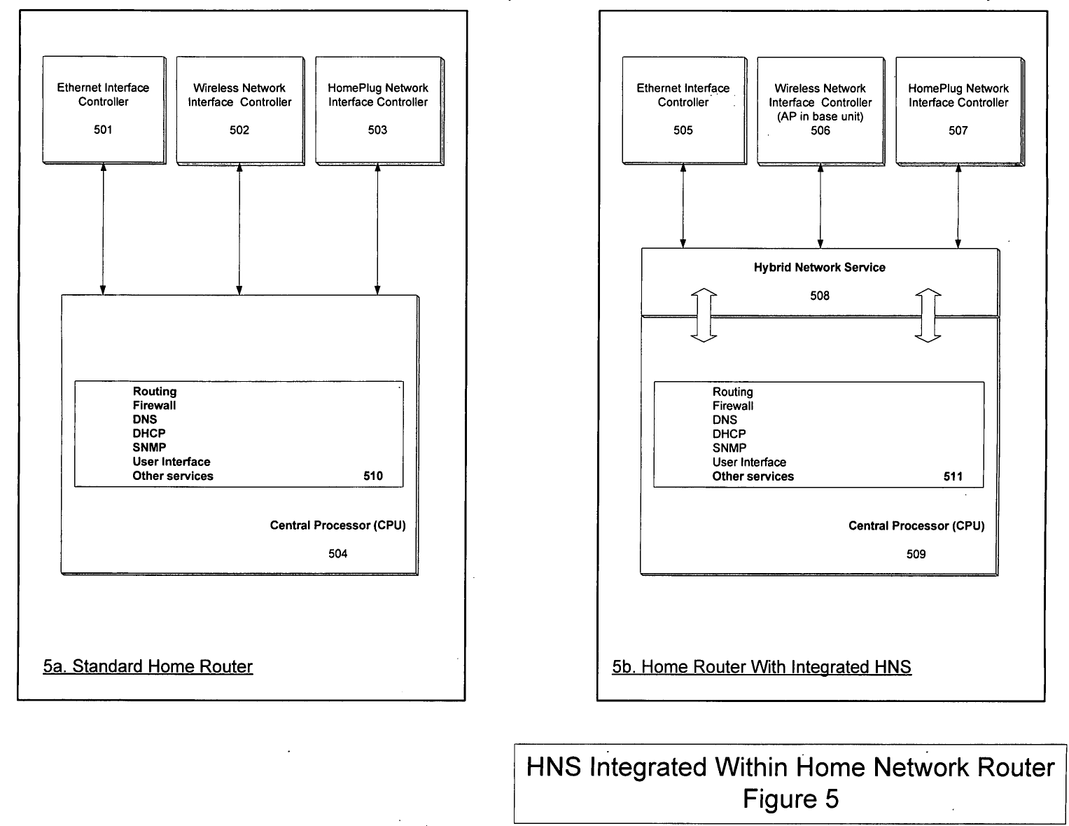

FIG. 5 shows a standard home router without HNS and the same router with integrated HNS.

FIG. 5a shows a router with three network interface controllers, 501, 502, 503, a CPU 504, and the various services 510 running on that CPU.

FIG. 5b shows the same router with HNS 508 integrated as a central service on or parallel to the CPU 509 and the various services 511. The arrows to the interfaces 505, 506, 507 indicate the control access and relationship that HNS has with them. While HNS is shown as being somewhat different from the other services implemented on the CPU, HNS could be implemented on the CPU similar to other services if the CPU is powerful enough and can provide the necessary network interface access and control. Otherwise HNS could be implemented on a more powerful CPU or on a separate controller. The depiction of HNS in it's own block 508 is for clarity not necessarily to indicate design.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. An apparatus for data transfer comprising:
a first network;
a second network; and
a plurality of nodes on said first network wherein secured data is transferred between at least two nodes of said plurality of nodes on said first network only if said at least two nodes also exist on said second network.

2. The apparatus of claim 1 wherein unsecured data is freely transferred between said at least two nodes on said first network.

3. The apparatus of claim 1 wherein unsecured data is freely transferred between said at least two nodes on said second network.

4. The apparatus of claim 1 wherein said at least two nodes exist on said second network for the entire period of said data transfer across said first network.

5. The apparatus of claim 4 further including security negotiation for use of said first network wherein said security negotiation data is transferred between said at least two nodes only over said second network.

6. The apparatus of claim 4 wherein said first network is a wireless network.

7. The apparatus of claim 4 wherein said second network is a private network.

8. The apparatus of claim 4 further including at least one interface module for communicating with data resources.

9. The apparatus of claim 5 wherein said security negotiation further includes at least one authentication key.

10. The apparatus of claim 7 wherein said private network is a wired network.

11. The apparatus of claim 9 wherein said authentication key is periodically changed.

12. The apparatus of claim 9 wherein said authentication key is randomly changed.

13. The apparatus of claim 9 wherein said authentication key is established by one of the group consisting of the manufacturer, the service provider, the end user and a predetermined algorithm.

14. The apparatus of claim 10 wherein said private network has predetermined physical boundaries.

15. The apparatus of claim 11 wherein said wired network is selected from the group comprising facility electrical wiring network, a home PNA telephone wiring network, a standard wired Ethernet network, and a coaxial cable network.

16. The apparatus of claim 14 wherein said private network further includes predetermined physical access points.

17. The apparatus of claim 14 wherein said physical access points include at least one selected from the group consisting of electrical outlets, phone jacks, and Ethernet jacks.

18. A method for data transfer, the method comprising the steps of:
providing a first network;
providing second network;
authenticating a relationship between at least two nodes on said second network;
transferring data between said at least two nodes on said first network;
re-authenticating a relationship between at least two nodes on said second network; and
de-authenticating a relationship between at least two nodes.

19. The method of claim 18 wherein said step of determining whether at least two nodes of said plurality of nodes exist on both said first network and said second network further includes:
requesting mutual authentication of said relationship between at least two nodes of said plurality of nodes via said first network to allow data transfer between said at least two nodes of said plurality of nodes over said second network; and
authenticating said at least two nodes of said plurality of nodes.

20. The method of claim 19 wherein said step of authenticating said at least two nodes of said plurality of nodes is repeated periodically on said second network throughout the duration of said data transfer.

21. The method of claim 20 wherein said step of de-authenticating said relationship between at least two nodes is conducted on said second network.

22. The a method of claim 21 wherein said first network is a wireless network and said second network is a private network.

23. An apparatus for data transfer, the method comprising the steps of:
means for providing a first network;
means for providing second network;
means for authenticating a relationship between at least two nodes on said second network;
means for transferring data between said at least two nodes on said first network;
means for re-authenticating a relationship between at least two nodes on said second network; and
means for de-authenticating a relationship between at least two nodes on said second network.

24. The apparatus of claim 23 wherein said step of determining whether at least two nodes of said plurality of nodes exist on both said first network and said second network further includes:
means for requesting mutual authentication of said relationship between at least two nodes of said plurality of nodes via said first network to allow data transfer between said at least two nodes of said plurality of nodes over said second network; and
means for authenticating said at least two nodes of said plurality of nodes.

25. The apparatus of claim 24 wherein said first network is a wireless network and said second network is a private network.

26. An apparatus for data transfer comprising:
at least one interface module for communicating with data resources;
a home wired network interface module for sending and receiving control packets and security packets;
a wireless network interface module for sending and receiving data packets; and
a processing unit for encapsulating data packets, de-encapsulating said data packets, processing said security packets, processing said control packets, detecting a second processing unit on both said home wired network and said wireless network and delivering said data packets on said wireless network interface module to said second processing unit.

27. The apparatus of claim 26 wherein said data resources are selected from the group comprising internet, cable, telephone, digital versatile disc, personal video recorder, personal computer and video camera.

28. The apparatus of claim 26 wherein said apparatus is integrated within home entertainment and computing equipment.
